(19) United States
(12) Patent Application Publication
(10) Pub. No.: US 2024/0326089 A1
(43) Pub. Date: Oct. 3, 2024

(54) COATING DEVICE, METHOD, AND ELECTRODE

(71) Applicant: Volkswagen Aktiengesellschaft, Wolfsburg (DE)

(72) Inventors: Ludger BUSSWINKEL, Braunschweig (DE); Sven SCHOPF, Braunschweig (DE); Sebastian REUBER, Dresden (DE); Roland SCHMIDT-LOBACH, Hoersingen (DE)

(73) Assignee: Volkswagen Aktiengesellschaft, Wolfsburg (DE)

(21) Appl. No.: 18/621,963

(22) Filed: Mar. 29, 2024

(30) Foreign Application Priority Data
Mar. 30, 2023 (DE) 10 2023 202 931.6

(51) Int. Cl. B05D 1/28; B05C 1/08; H01M 4/02; H01M 4/04

(52) U.S. Cl. CPC B05D 1/28; B05C 1/0813; B05C 1/0865; H01M 4/0404; H01M 4/0435; H01M 2004/021

(57) ABSTRACT

A coating device for manufacturing an electrode on a substrate. A feed unit feeds a substrate into a pressing gap. A first metering unit accommodates a first powder and a second powder and parallel fills a first metering gap with the first powder and the second powder. A roller device has a first application roller, a first pressing roller unit, and a second pressing roller unit. The first metering gap is provided between the first application roller and the first pressing roller unit, and the pressing gap is provided between the first pressing roller unit and the second pressing roller unit. The first metering gap is provided for applying the first powder and the second powder, as a first at least two-ply layer to the first pressing roller unit via a first application force.

This nonprovisional application claims priority under 35 U.S.C. § 119(a) to German Patent Application No. 10 2023 202 931.6, which was filed in Germany on Mar. 30, 2023, and which is herein incorporated by reference.

### BACKGROUND OF THE INVENTION

### Field of the Invention

The invention relates to a coating device for manufacturing an electrode having at least a two-ply powder layer on a substrate, a method for manufacturing an electrode having at least a two-ply powder layer, and an electrode having a two-ply powder layer.

### Description of the Background Art

Electrodes with a single-layer coating have been produced thus far in attempts for solvent-free or dry electrode manufacture. To improve the performance of battery cells, conventional electrode manufacture takes the approach of manufacturing electrodes with multilayer coatings (different compositions of the individual layers), since these coatings have an increased energy density and electrical conductivity.

At the present time, electrodes having a multilayer coating and that are manufactured without solvent are often produced as a standalone film. In the process, two powders are pressed in a calender gap at a current collector.

However, the electrode is still normally processed wet, and thus contains solvent.

Another method is the successive application of individual layers to the sides of a substrate provided for this purpose. This can be achieved by applying and pressing in each case the individual layers as a standalone film, for example in two calender gaps arranged in succession.

However, this often requires adhesion promoters or a certain moisture level of the powder, since otherwise it is not possible to ensure adhesion of the respective layers. This may result in a substrate or current collector that is not continuously coated. This in turn results in a higher reject rate or lower electrical power of an electrode manufactured in this way.

### SUMMARY OF THE INVENTION

It is therefore an object of the present invention to at least overcome the disadvantages described above. In particular, an object of the invention is to provide a coating device that allows dry electrode manufacture, so that the electrical conductivity or the energy density of the electrode is increased. A further object of the invention is to provide a method for dry electrode manufacture, and an electrode manufactured in this way.

Features and details that are described in conjunction with the coating device according to the invention also apply in conjunction with the method according to the invention and/or and in conjunction with the electrode according to the invention, and vice versa in each case, so that with regard to the disclosure, mutual reference is or may always be made to the individual aspects of the invention.

In the invention, according to a first aspect of the invention a coating device for manufacturing an electrode having at least one two-ply powder layer, in particular a two-ply cathode layer and/or anode layer, on a substrate, in particular a current collector, is provided. The coating device has a feed unit for feeding a substrate into a pressing gap, a first metering unit for accommodating a first powder and a second powder and for parallel filling of a first metering gap with the first powder and the second powder, and a roller device, the roller device having a first application roller, a first pressing roller unit, and a second pressing roller unit. The first metering gap is provided between the first application roller and the first pressing roller unit, and the pressing gap is provided between the first pressing roller unit and the second pressing roller unit. The first metering gap is provided for applying the first powder and the second powder, as a first at least two-ply layer, to the first pressing roller unit by means of a first application force. The pressing gap is provided for transferring the first at least two-ply layer from the first pressing roller unit to a first side of the supplied substrate by means of a pressing force.

The coating device can be based on a roller-borne coating in which initially the at least two-ply layer is applied to a roller, and is then transferred or pressed from the roller to/onto the substrate. This is particularly advantageous for coating a substrate with a solvent-free, dry powder material, so that the coating device is very well suited for dry electrode manufacture.

The first pressing roller unit and the second pressing roller unit in the present case may each have a pressing roller. To apply the pressing force for transferring the at least two-ply layer, the pressing rollers of the first and second pressing roller units, which form the pressing gap, rotate relative to one another at the same rotational speed in order to provide an optimal coating result. The first application roller may have a lower rotational speed than the pressing roller of the first pressing roller unit, which together with the first application roller forms the metering gap, thus ensuring that the first powder and the second powder as a first layer remain adherent to the first pressing unit in order to be carried by it.

Since the first metering unit as well as the first and second powders are metered at the same time, it is possible to apply the desired two-ply layer in one pressing operation, i.e., one pass through the pressing gap. It must be ensured that the first powder and the second powder are filled next to one another, and intermix only in a border area. To reduce the intermixing of the first powder and the second powder, it is conceivable for the first metering unit to have a first chamber for the first powder and a second chamber for the second powder.

The proportion of the first powder and of the second powder in the first layer may be variable in order to create different layer thicknesses. For this purpose, it is conceivable to provide a control unit that controls and/or regulates the proportion of the respective powder.

Furthermore, the efficiency of the coating device is increased due to the parallel and simultaneous metering or filling of the metering gap, since only one roller device is necessary to apply a two-ply powder layer to the substrate. As the result of simultaneously applying the two-ply powder layer, the formation of a boundary layer between the two powder layers is reduced or prevented, thus improving the adhesion and the electrical connection.

A second metering unit can be provided for accommodating a third powder and a fourth powder, and to fill a second metering gap with the third powder and the fourth powder in parallel, and for the roller device to have at least one second application roller, the second metering gap being provided between the second application roller and the second pressing roller unit. The second metering gap is provided for applying the third powder and the fourth powder, as a second at least two-ply layer, to the second pressing roller unit by means of a second application force. The pressing gap between the first and the second pressing roller units is provided for transferring the second at least two-ply layer from the second pressing roller unit to a second side of the supplied substrate by means of the pressing force.

The second application roller may have a lower rotational speed than the pressing roller of the second pressing roller unit, which together with the second application roller forms the metering gap, thus ensuring that the third powder and the fourth powder as a second layer remain adherent to the second pressing unit in order to be carried by it.

Since the second metering unit as well as the third and fourth powders can be metered at the same time, it is possible to apply the desired two-ply layer in one pressing operation, i.e., one pass through the pressing gap. It must be ensured that the third powder and the fourth powder are filled next to one another, and intermix only in a border area. To reduce the intermixing of the third powder and the fourth powder, it is conceivable for the second metering unit to have a third chamber for the third powder, and a fourth chamber for the fourth powder.

The proportion of the third powder and of the fourth powder in the second layer may be variable in order to create different layer thicknesses. For this purpose, it is conceivable for the control unit to control and/or regulate the proportion of the respective powder.

In addition, the first powder and the third powder can have the same composition, and/or for the second powder and the fourth powder to have the same composition.

The first pressing roller unit can have at least one first pressing roller and at least one second pressing roller, at least one first compressing gap being provided between the at least one first pressing roller and the at least one second pressing roller. Additionally or alternatively, the second pressing roller unit has at least one third pressing roller and at least one fourth pressing roller, at least one second compressing gap being provided between the at least one third pressing roller and the at least one fourth pressing roller.

The first compressing gap and/or the second compressing gap compress(es) the first layer or the second layer before it is transferred to the substrate. Denser packing of the first layer and of the second layer may thus be achieved, so that the electrical conductivity may be further improved. In addition, a compressing gap has the additional effect that lower forces for applying or transferring have to act in the metering gap and in the pressing gap, so that the shear forces acting in the gaps may be reduced. This results in uniform application and transfer, and reduces flaws during application or transfer.

It is also conceivable here for the first pressing roller unit and/or the second pressing roller unit to have further pressing rollers, and thus, associated further compressing gaps.

The first metering unit can have a first separating plate for separating the first powder and the second powder in the region of the first metering gap. Additionally or alternatively, the second metering unit has a second separating plate for separating the third powder and the fourth powder in the region of the second metering gap.

The first separating plate or the second separating plate may protrude only into the region of the first metering gap or of the second metering gap without closing the respective metering gap. The separating plates are used to separate the individual powders until just before the powder is applied as a first layer or second layer. The separating plates result in reduced intermixing in the border area of the first layer or second layer, which is particularly advantageous for the energy density of the first layer or second layer.

The first separating plate and/or the second separating plate can have a structure. This structure may comb through the particular powder in order to break up any clumps that are present, and/or may result in better transport into the metering gap. It is also conceivable for the separating plates to be set in vibration by electrical and/or pneumatic excitation, as a result of which the transport may be additionally improved.

It may be provided, in the vicinity of the first metering gap, a first shielding plate in the region of the first application roller and/or a second shielding plate in the region of the first pressing roller unit, and/or, in the vicinity of the second metering gap, a third shielding plate in the region of the second application roller and/or a fourth shielding plate in the region of the second pressing roller unit.

The shielding plates prevent the powder from already lying on the first and/or second pressing roller unit prior to the metering gap, or from adhering to the first and/or second application roller. At the same time, by use of such shielding plates, the entry of powder into the first metering gap and/or the second metering gap may be easily controlled. It is also conceivable for the shielding plates to have a structure for cleaning or removing adhering materials from the first and/or second application roller and/or the first and/or second pressing roller unit. This allows the cleanest possible application of a new first layer or second layer, or a clean transfer of the first and/or second layer to the substrate.

Furthermore, in the coating device it is conceivable for the first application roller and/or the second application and/or the first pressing roller unit and/or the second pressing roller unit to be temperature-controllable.

In addition, according to a second aspect of the invention, the above object is achieved by a method according to the invention for manufacturing an electrode having at least a two-ply powder layer, in particular a two-ply cathode layer and/or anode layer, on a substrate, in particular a current collector, in a coating device described above, comprising the following steps: feeding a substrate into the pressing gap by means of the feed unit; parallel filling of the first metering gap with the first powder and with the second powder by means of the first metering unit; applying the first powder and the second powder, as the first at least two-ply layer, to the first pressing roller unit in the first metering gap by means of the first application force; transferring the first at least two-ply layer to the first side of the substrate in the first pressing gap by means of a pressing force.

Due to the simultaneous application of the first and second powders to the substrate as a first layer, the respective forces applied to the individual powders of the layers may be reduced or evenly distributed.

The second metering unit can fill the second metering gap with the third powder and with the fourth powder in parallel, the third powder and the fourth powder, as the second at least two-ply layer in the second metering gap, being applied to the second pressing roller unit by means of the second application force, and for the second at least two-ply layer in the pressing gap to be transferred to the second side of the substrate by means of the pressing force.

The substrate may also be provided with an at least two-ply powder layer on the second side by means of the second metering unit and the second metering gap. In this way, in the case of electrode manufacture the anode layer as well as the cathode layer may be applied to the substrate or to the current collector in one step.

It is also possible for the first metering unit to continuously fill the first metering gap, and/or for the second metering unit to continuously fill the second metering gap.

This provides a particularly uniform result in the production of the at least two-ply layer on the particular side of the substrate.

Furthermore, within the scope of the invention it may be provided that the first metering unit meters the first powder and the second powder in such a way that a first layer thickness of 40 to 150 μm results for the first at least two-ply layer in the pressing gap, wherein a first layer made of the first powder has a layer thickness of 10 to 70 μm. Additionally or alternatively, the second metering unit meters the third powder and the fourth powder in such a way that a second layer thickness of 40 to 150 μm results for the second at least two-ply layer in the pressing gap, wherein a third layer made of the third powder has a layer thickness of 10 to 70 μm.

These layer thicknesses or the required material quantity are specified by the first or second metering unit, and are created by the first application force in the first metering gap or by the second application force in the second metering gap, and by the pressing force in the pressing gap. This may be controlled and/or regulated by means of a control unit.

The first at least two-ply layer can be compressed in the at least one first compressing gap of the first pressing roller unit, and/or for the second at least two-ply layer to be compressed in the at least one second compressing gap of the second pressing roller unit.

The compression in the particular compressing gap results in compaction of the first layer and/or second layer in order to achieve denser packing of the particular at least two-ply powder layer on the first side and/or the second side of the substrate. This allows a reduction in the first application force and/or the second application force and/or the pressing force.

The first application roller and/or the second application and/or the first pressing roller unit and/or the second pressing roller unit can be controlled to a temperature between 80° C. and 150° C., in particular between 100° C. and 120° C.

This allows improved application of the first and second powders, as a first layer, to the first pressing roller unit, and/or of the third and fourth powders, as a second layer, to the second pressing roller unit. In addition, by controlling the temperature of the individual rollers, the transfer of the first layer to the first side of the substrate and/or of the second layer to the second side of the substrate may be improved, since the bonding of the individual powders of the respective layers is increased due to the heat.

The feed unit can be temperature-controlled in order to preheat the substrate for the transfer, i.e., the pressing of the first layer onto the first side of the substrate and/or of the second layer onto the second side of the substrate.

The first pressing roller unit and the second pressing roller unit can rotate relative to one another at the same first rotational speed, the ratio of the first rotational speed of the first pressing roller unit to a second rotational speed of the first application roller being 10:1 to 10:4, preferably 10:1.5 to 10:3, more preferably 10:2 to 10:3, and/or the ratio of the first rotational speed of the second pressing roller unit to the third rotational speed of the second application roller being 10:1 to 10:4, preferably 10:1.5 to 10:3, more preferably 10:2 to 10:3.

If the first pressing roller unit includes the first and second pressing rollers, and/or the second pressing roller unit includes the third and fourth pressing rollers, the first rotational speed may be considered to be the rotational speed of the first pressing roller of the first pressing roller unit, and the rotational speed of the third pressing roller of the second pressing roller unit, since they form the pressing gap. The second pressing roller and the fourth pressing roller may each have a rotational speed that differs from the first rotational speed.

It has advantageously turned out that the ratios of the rotational speeds result in increased stability of the first layer or of the first at least two-ply powder layer on the current collector of the electrode, and/or of the second layer or the second at least two-ply powder layer on the current collector of the electrode.

In addition, according to a third aspect of the invention, the above object is achieved by an electrode according to the invention having a two-ply powder layer, which is manufactured using a coating device described above and/or a method described above, wherein the substrate is a current collector having a first side and a second side, and the first at least two-ply layer is made of the first powder and the second powder.

The second at least two-ply layer can be made of the third powder and the fourth powder.

The electrode may be used as an anode or as a cathode. It is conceivable for the two-ply powder layer of the cathode to be different from the two-ply powder layer of the anode. It is also conceivable for the current collector of the anode to be different from the current collector of the cathode.

This type of electrode has an optimally compacted first and/or second at least two-ply layer, wherein the first and/or second at least two-ply layer are/is free of solvent. At the same time, an electrode manufactured in this way has a high electrical conductivity and energy density.

A particularly good ratio of material usage of the first, second, third, and fourth powders for the first and/or second at least two-ply layer of an electrode, or of an anode or cathode, to the existing electrical conductivity results when the first at least two-ply layer and the second at least two-ply layer have a layer thickness between 40 and 150 μm, the first powder of the first layer and the third powder of the third layer having a layer thickness of 10 to 70 μm. In this way, cost-effective material usage may also be provided.

Advantages that have been described with regard to the coating device according to the first aspect of the invention likewise apply to the method according to the second aspect of the invention, and to the electrode according to the third aspect of the invention.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a schematic illustration of a coating device for applying and transferring a first layer;

FIG. 2 shows a schematic illustration of a coating device for applying and transferring a first layer and a second layer;

FIG. 3 shows a detail of a first metering gap from FIG. 1;

FIG. 4 shows a schematic illustration of a method using a coating device according to FIG. 1;

FIG. 5 shows a schematic illustration of a method using a coating device according to FIG. 2; and

FIG. 6 shows a schematic illustration of an electrode.

### DETAILED DESCRIPTION

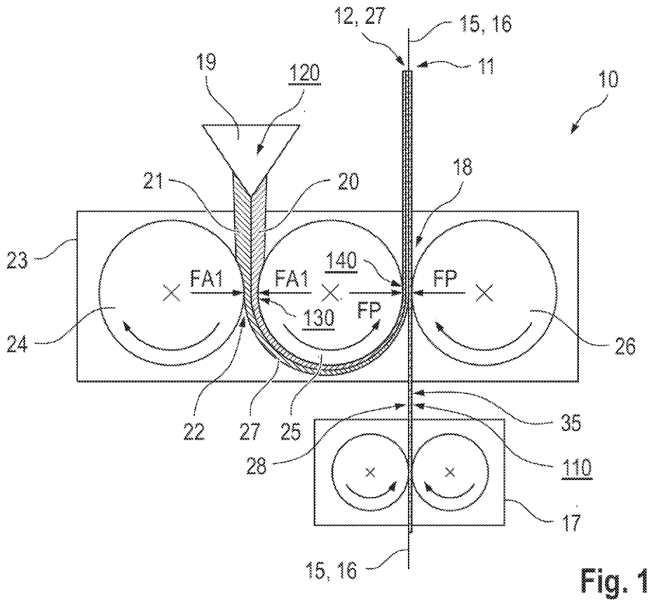

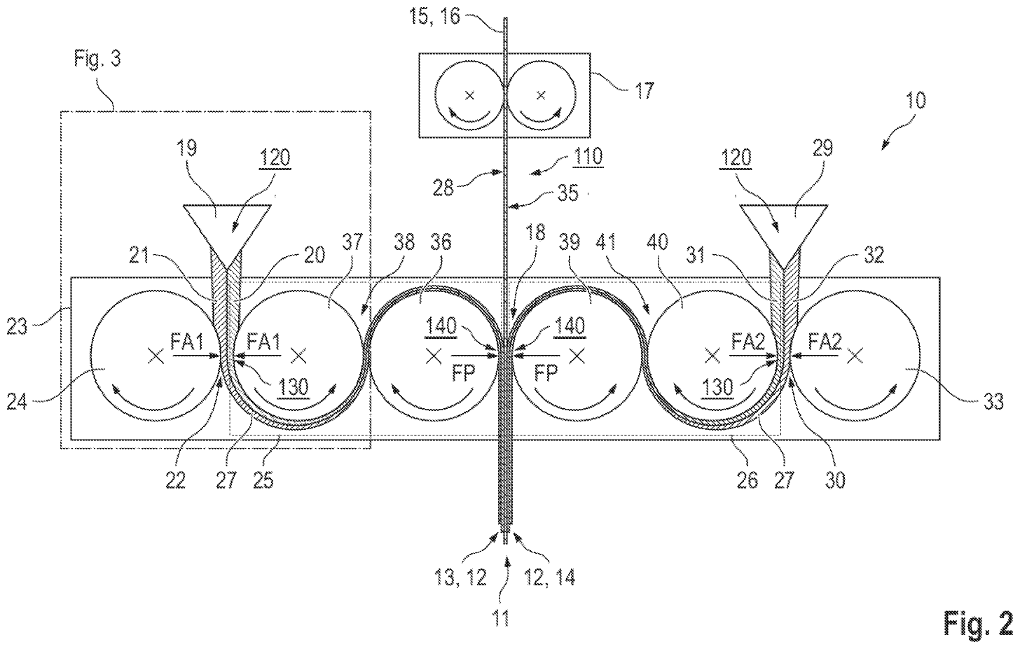

FIGS. 1 and 2 each illustrate a coating device 10 for manufacturing an electrode 11 having at least one two-ply powder layer 12, in particular a two-ply cathode layer 13 and/or anode layer 14, on a substrate 15, in particular a current collector 16. FIG. 1 shows a coating device 10 for one-sided coating of a substrate 15 by application 130 and transfer 140 of the at least one first two-ply powder layer 12, and FIG. 2 shows a coating device 10 for two-sided coating of a substrate 15 by application 130 and transfer 140 of the at least one first two-ply powder layer 12 (first two-ply layer 27) and the at least one second two-ply powder layer 12 (second two-ply layer 34).

The coating device 10 in both FIG. 1 and FIG. 2 has a feed unit 17 for feeding 110 a substrate 15 into a pressing gap 18, a first metering unit 19 for accommodating a first powder 20 and a second powder 21 and for parallel filling 120 of a first metering gap 22 with the first powder 20 and the second powder 21, and a roller device 23, the roller device 23 having a first application roller 24, a first pressing roller unit 25, and a second pressing roller unit 26.

The first metering gap 22 is provided between the first application roller 24 and the first pressing roller unit 25, and the pressing gap 18 is provided between the first pressing roller unit 25 and the second pressing roller unit 26.

The first metering gap 22 is provided for applying 130 the first powder 20 and the second powder 21 as a first at least two-ply layer 27 to the first pressing roller unit 25 by means of a first application force FA1. The pressing gap 18 is provided for transferring 140 the first at least two-ply layer 27 from the first pressing roller unit 25 to a first side 28 of the supplied substrate 15 by means of a pressing force FP.

To enable a two-ply powder layer 12 to be applied 130 to a substrate 15 on both sides, the coating device 10 in FIG. 2 has a second metering unit 29 for accommodating a third powder 31 and a fourth powder 32, and parallel filling 120 of a second metering gap 30 with the third powder 31 and the fourth powder 32. In addition, the roller device 23 has at least one second application roller 33. The second metering gap 30 is provided between the second application roller 33 and the second pressing roller unit 26, and the second metering gap 30 is provided for applying 130 the third powder 31 and the fourth powder 32, as a second at least two-ply layer 34, to the second pressing roller unit 26 by means of a second application force FA2. In this case, the pressing gap 18 is also provided for transferring 140 the second at least two-ply layer 34 from the second pressing roller unit 26 to a second side 35 of the supplied substrate 15 by means of a pressing force FP.

As illustrated in FIG. 2, for example, the first pressing roller unit 25 has at least one first pressing roller 36 and at least one second pressing roller 37, at least one first compressing gap 38 being provided between the at least one first pressing roller 36 and the at least one second pressing roller 37. In addition, the second pressing roller unit 26 has at least one third pressing roller 39 and at least one fourth pressing roller 40, at least one second compressing gap 41 being provided between the at least one third pressing roller 39 and the at least one fourth pressing roller 40.

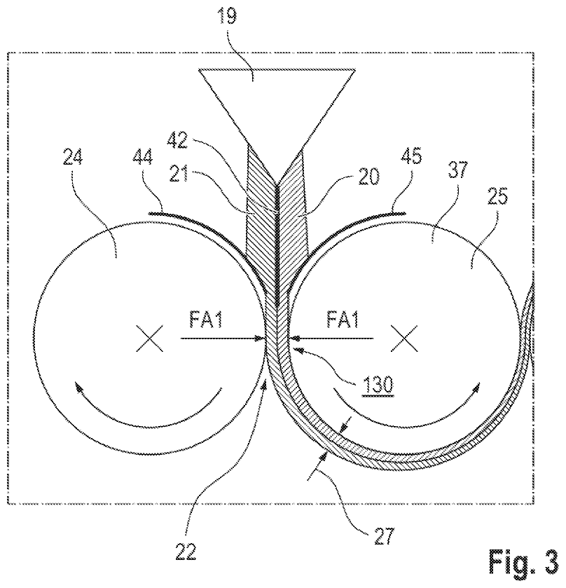

FIG. 3 illustrates an enlarged detail of a first metering gap 22 together with a first metering unit 19. Here, the first metering unit 19 has a first separating plate 42 for separating the first powder 20 and the second powder 21 in the region of the first metering gap 22. Further separating plates may also be analogously provided for the second metering unit 29 and the second metering gap 30.

In addition, the detail in FIG. 3 shows that a first shielding plate 44 is provided in the vicinity of the first application roller 24, in the region of the first metering gap 22, and/or that a second shielding plate 45 is provided in the vicinity of the first pressing roller unit 25. Analogously, it is also possible to provide a third shielding plate 46 in the vicinity of the second application roller 33, in the region of the second metering unit 29 or the second metering gap 30, and/or to provide a fourth shielding plate 47 in the vicinity of the second pressing roller unit 26.

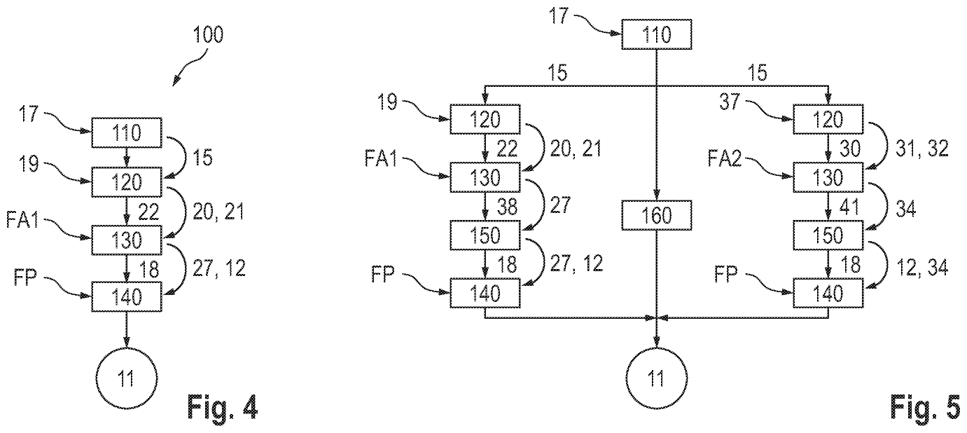

FIGS. 4 and 5 each schematically show the method 100 for manufacturing an electrode 11 having at least one two-ply powder layer 12, in particular a two-ply cathode layer 13 and/or anode layer 14, on a substrate 15, in particular a current collector 16, in a coating device 10 according to FIG. 1 or 2: feeding 110 a substrate 15 into the pressing gap 18 by means of the feed unit 17; parallel filling 120 of the first metering gap 22 with the first powder 20 and with the second powder 21 by means of the first metering unit 19; applying 130 the first powder 20 and the second powder 21, as a first at least two-ply layer 27, to the first pressing roller unit 25 in the first metering gap 22 by means of the first application force FA1; and transferring 140 the first at least two-ply layer 27 to the first side 28 of the substrate 15 in the first pressing gap 18 by means of a pressing force FP.

In a method 100 according to FIG. 5, which is carried out in the coating device 10 according to FIG. 2, the second metering unit fills 120 the second metering gap 30 with the third powder 31 and with the fourth powder 32 in parallel. The third powder 31 and the fourth powder 32, as a second at least two-ply layer 34 in the second metering gap 30, are applied 130 to the second pressing roller unit 26 by means of the second application force FA2, and the second at least two-ply layer 34 in the pressing gap 18 is subsequently transferred 140 to the second side 35 of the substrate 15 by means of the pressing force FP.

For both examples of the coating device 10 or of the method 100, the first metering unit 19 in FIGS. 1 and 2 or FIGS. 4 and 5 continuously fills 120 the first metering gap, and the second metering unit 29 in FIG. 2 or FIG. 5 continuously fills 120 the second metering gap 30.

The first metering unit 19 meters the first powder 20 and the second powder 21 in such a way that a first layer thickness SD1 of 40 to 150 μm results for the first at least two-ply layer 27 in the pressing gap 18, wherein a first layer 48 made of the first powder 20 has a layer thickness SP1 of 10 to 70 μm. The same applies for the second metering unit 29, which also meters the third powder 31 and the fourth powder 32 in such a way that a second layer thickness SD2 of 40 to 150 μm results for the second at least two-ply layer 34 in the pressing gap 18, wherein a third layer 49 made of the third powder 31 has a layer thickness SP3 of 10 to 70 μm.

The coating device 10 according to FIG. 2, as described above, has a first pressing roller 36 and a second pressing roller 37 in the first pressing roller unit 25, and has a third pressing roller 39 and a fourth pressing roller 40 in the second pressing roller unit 26.

Accordingly, the first at least two-ply layer 27 is compressed 150 in the at least one first compressing gap 38 of the first pressing roller unit 25, and the second at least two-ply layer 34 is compressed 150 in the at least one second compressing gap 41 of the second pressing roller unit 26.

For optimal application and transfer, in the coating device 10 according to FIG. 2 in the method 100 according to FIG. 5, the first application roller 24 and the second application roller 33 and the first pressing roller unit 25 and the second pressing roller unit 26 are controlled 160 to a temperature between 80° C. and 150° C. Each of the rollers may be controlled 160 to a separate temperature.

In the method 100 according to FIGS. 4 and 5, the first pressing roller unit 25 and the second pressing roller unit 26 rotate relative to one another at the same first rotational speed v1. The ratio of the first rotational speed v1 of the first pressing roller unit 25 to a second rotational speed v2 of the first application roller 24 is 10:1 to 10:4. In the method 100 according to FIG. 5, a second application roller 33 is provided; here, the ratio of the first rotational speed v1 of the second pressing roller unit 26 to the third rotational speed v3 of the second application roller 33 is 10:1 to 10:4.

However, in the method 100 according to FIG. 5, the second rotational speed v2 of the first application roller 24 v1 does not have to correspond to the third rotational speed v3 of the second application roller 33. In the method 100 according to FIG. 5, including the coating device 10 according to FIG. 2, the first rotational speed v1 is the rotational speed of the first pressing roller 36 of the first pressing roller unit 25, and is the rotational speed of the third pressing roller 39 of the second pressing roller unit 26, since they form the pressing gap 18. The second pressing roller 37 and the fourth pressing roller 40 may have a rotational speed that is different from the first rotational speed v1.

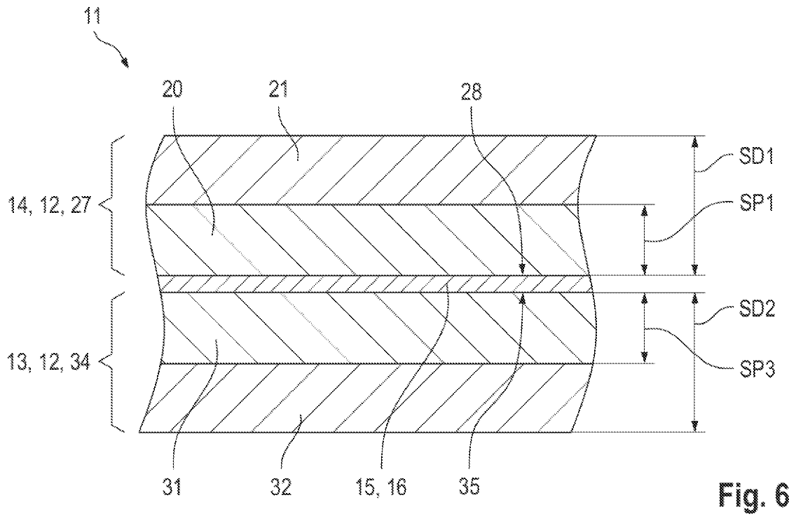

FIG. 6 illustrates an electrode 11, as manufactured in a coating device 10 according to FIG. 2 and by use of the method 100 according to FIG. 5, having a first and a second two-ply powder layer 12 on a substrate 15. The substrate 15 is a current collector 16 having a first side 28 and a second side 35, wherein the first at least two-ply layer 27, i.e., the first two-ply powder layer 12, is made of the first powder 20 and the second powder 21. In addition, the second at least two-ply layer 34, i.e., the second two-ply powder layer 12, is made of the third powder 31 and the fourth powder 32.

The anode layer 14 has a first layer thickness SD1 and the cathode layer 13 has a second layer thickness SD2, each between 40 and 150 μm, wherein the first powder 20 of the first layer 48 has a first layer thickness SP1 of 10 to 70 μm, and the third powder 31 of the third layer 49 has a second layer thickness SP2 of 10 to 70 μm. In this way, cost-effective material usage may also be provided.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A coating device to manufacture an electrode having at least one two-ply powder layer and/or a two-ply cathode layer and/or anode layer on a substrate or a current collector, the coating device comprising:
a feed unit to feed a substrate into a pressing gap;
a first metering unit to accommodate a first powder and a second powder and for parallel filling of a first metering gap with the first powder and the second powder; and
a roller device having a first application roller, a first pressing roller unit, and a second pressing roller unit,
wherein the first metering gap is provided between the first application roller and the first pressing roller unit,
wherein the pressing gap is provided between the first pressing roller unit and the second pressing roller unit,
wherein the first metering gap is provided to apply the first powder and the second powder as a first at least two-ply layer to the first pressing roller unit via a first application force, and
wherein the pressing gap transfers the first at least two-ply layer from the first pressing roller unit to a first side of the supplied substrate via a pressing force.

2. The coating device according to claim 1, further comprising a second metering unit to accommodate a third powder and a fourth powder and for parallel filling of a second metering gap with the third powder and the fourth powder,
wherein the roller device has at least one second application roller,
wherein the second metering gap is provided between the second application roller and the second pressing roller unit,
wherein the second metering gap is provided for applying the third powder and the fourth powder as a second at least two-ply layer to the second pressing roller unit via a second application force, and
wherein the pressing gap is provided for transferring the second at least two-ply layer from the second pressing roller unit to a second side of the supplied substrate via a pressing force.

3. The coating device according to claim 1, wherein the first pressing roller unit has at least one first pressing roller and at least one second pressing roller, at least one first compressing gap being provided between the at least one first pressing roller and the at least one second pressing roller, and/or wherein the second pressing roller unit has at least one third pressing roller and at least one fourth pressing roller, at least one second compressing gap being provided between the at least one third pressing roller and the at least one fourth pressing roller.

4. The coating device according to claim 1, wherein the first metering unit has a first separating plate for separating the first powder and the second powder in a region of the first metering gap and/or the second metering unit has a second separating plate for separating the third powder and the fourth powder in a region of the second metering gap.

5. The coating device according to claim 1, wherein, in a vicinity of the first metering gap, a first shielding plate is provided in a region of the first application roller and/or a second shielding plate is provided in a region of the first pressing roller unit, and/or wherein, in a vicinity of the second metering gap, a third shielding plate is provided in a region of the second application roller and/or a fourth shielding plate is provided in a region of the second pressing roller unit.

6. A method for manufacturing an electrode having at least one two-ply powder layer, in particular a two-ply cathode layer and/or anode layer on a substrate, in particular a current collector, in a coating device according to claim 1, the method comprising:
feeding a substrate into the pressing gap via the feed unit;
parallel filling the first metering gap with the first powder and with the second powder via the first metering unit;
applying the first powder and the second powder, as the first at least two-ply layer, to the first pressing roller unit in the first metering gap via the first application force;
transferring the first at least two-ply layer to the first side of the substrate in the first pressing gap via a pressing force.

7. The method according to claim 6, wherein the second metering unit fills the second metering gap with the third powder and with the fourth powder in parallel, the third powder and the fourth powder, as the second at least two-ply layer in the second metering gap, being applied to the second pressing roller unit via the second application force, and wherein the second at least two-ply layer in the pressing gap is transferred to the second side of the substrate via the pressing force.

8. The method according to claim 6, wherein the first metering unit continuously fills the first metering gap and/or wherein the second metering unit continuously fills the second metering gap.

9. The method according to claim 6, wherein the first metering unit meters the first powder and the second powder such that a first layer thickness of 40 to 150 μm results for the first at least two-ply layer in the pressing gap, wherein a first layer made of the first powder has a layer thickness of 10 to 70 μm, and/or wherein the second metering unit meters the third powder and the fourth powder such that a second layer thickness of 40 to 150 μm results for the second at least two-ply layer in the pressing gap, wherein a third layer made of the third powder has a layer thickness of 10 to 70 μm.

10. The method according to claim 6, wherein the first at least two-ply layer is compressed in the at least one first compressing gap of the first pressing roller unit, and/or wherein the second at least two-ply layer is compressed in the at least one second compressing gap of the second pressing roller unit.

11. The method according to claim 6, wherein the first application roller and/or the second application and/or the first pressing roller unit and/or the second pressing roller unit are/is controlled to a temperature between 80° C. and 150° C.

12. The method according to claim 6, wherein the first pressing roller unit and the second pressing roller unit rotate relative to one another at the same first rotational speed, wherein a ratio of the first rotational speed of the first pressing roller unit to a second rotational speed of the first application roller is 10:1 to 10:4 or 10:1.5 to 10:3 or 10:2 to 10:3, and/or wherein the ratio of the first rotational speed of the second pressing roller unit to the third rotational speed of the second application roller is 10:1 to 10:4, or 10:1.5 to 10:3 or 10:2 to 10:3.

13. An electrode comprising a two-ply powder layer that is manufactured using a coating device according to claim 1, wherein the substrate is a current collector having a first side and a second side, and wherein the first at least two-ply layer is made of the first powder and the second powder.

14. The electrode according to claim 13, wherein the second at least two-ply layer is made of the third powder and the fourth powder.
